(19) United States
(12) Patent Application Publication
(10) Pub. No.: US 2005/0242180 A1
(43) Pub. Date: Nov. 3, 2005

(54) Method and system for assisting a shopper

(75) Inventor: Roger Byford, Apollo, PA (US)

Correspondence Address: WOOD, HERRON & EVANS, LLP, 2700 CAREW TOWER, 441 VINE STREET, CINCINNATI, OH, 45202, US

(73) Assignee: Vocollect, Inc., Pittsburgh, PA (US)

(21) Appl. No.: 10/836,981

(22) Filed: Apr. 30, 2004

(51) Int. Cl. G06F 17/60

(52) U.S. Cl. 235/385

(57) ABSTRACT

A consumer uses a portable device to record voice input of items that are needed when shopping at a store. The device is then carried to the store when shopping and upon entering the store becomes connected to a wireless LAN within the store. Once on the LAN, the device can exchange information with a store computer such as by sending the list of voice inputs to the computer and receiving back information about the location of those items in the store. The received information is provided as audio output by the device. By including a locator service within the wireless LAN, the store computer is able to identify where the device is located and customize any announcements that the store computer sends to the device.

### TECHNICAL FIELD

The present invention relates to consumer electronics and, more particularly to a device to record voice input.

### BACKGROUND ART

Technology that simplifies peoples' lives is usually well-received in the marketplace, especially technology that addresses common, everyday tasks. One particular task most people perform on a regular basis is shopping, whether it is for groceries, for houseware items or other retail goods. Even though shopping is performed regularly, many people find it more efficient to make a single trip to the store to get multiple items rather than make a separate trip each time an item is needed.

However, the recognition that an item is needed may be more than a few days, or at least a few hours, before the trip to the store. Thus, a written, typed or other list is usually maintained by consumers so that all the needed items can be remembered when actually at the store. While keeping a list is a simple task, it is often inconvenient because the list has to be handy when a particular item is recognized as being needed. If the list is not handy, that particular item may or may not make it onto the list. The consumer may not always discover every item that may be needed and so some items may never make it on the list. Also, the consumer must remember to take the list to the store for it to be of any use while shopping. One other drawback of a list is that items are generally added to the list in the order they are thought of or remembered. This order rarely reflects the physical layout of these items within the store. Thus, the list must continually be scanned while shopping to ensure that all the items are found. Furthermore, the list provides no assistance in finding where throughout a store an item is located.

Additionally, a consumer usually must rely on coupons and other printed advertisements to determine what items are on sale or are part of a special promotion. It is not always easy to correlate such information with the specific brands that consumer might buy and to do so specifically when that particular item is needed or is on the list. Accordingly, consumers may pay too much for an item or miss an opportunity to purchase an item at a discount.

Thus, there is a need for a device that simplifies remembering what items to purchase at a store and also assists with the task of shopping for these and other items.

### BRIEF DESCRIPTION OF THE DRAWINGS

The accompanying drawings, which are incorporated in and constitute a part of this specification, illustrate embodiments of the invention and, together with the detailed description of the embodiments given below, serve to explain the principles of the invention.

FIG. 1 illustrates an exemplary device according to the principles of the present invention that stores voice input and interfaces with a wireless LAN.

FIG. 2 illustrates an exemplary store environment according to an embodiment of the present invention.

FIG. 3 illustrates an exemplary computer that operates within the environment of FIG. 2.

FIG. 4 depicts a flowchart of an exemplary method for using the device of FIG. 1.

### DETAILED DESCRIPTION OF SPECIFIC EMBODIMENTS

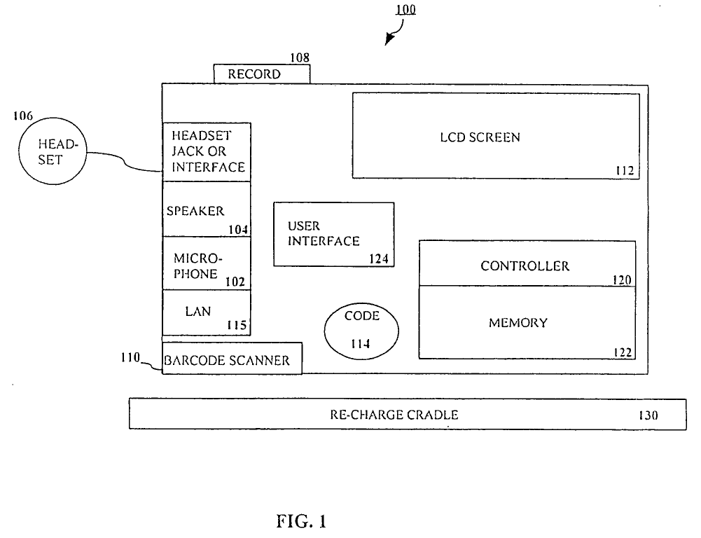

FIG. 1 illustrates an exemplary device in accordance with the principles of the present invention. The device 100 is advantageously small so that it may be unobtrusively stored in a pocket or purse. Also, the device 100 may include a belt clip or other clasp to allow it to be worn by a consumer. The device 100 may include a microphone 102 for receiving audio or voice input and a speaker 104 for producing audio output. Alternatively, the microphone 102 and speaker 104 may be provided via a headset 106, such as those commonly used with cellular phones. In another alternative, the headset 106 may be a wireless headset, as are known in the art, that communicates via a radio link with the device 100. The use of a wireless headset permits the device 100 to be located in a purse or pocket, or some other remote location, while still being utilized.

The device 100 further includes a push-to-talk button 108 or similar mechanism that is used to put the device 100 in a mode to record voice input received via the microphone 102. The device 100 may record the voice input for the entire time that the button is depressed or it may be configured to record the voice input for a predetermined time period after the button is depressed and released. In an alternative embodiment, receipt of voice input is automatically detected and, thus, after the button 108 is depressed, input is captured only during the time period that voice input is actually being received by the microphone.

The operation of the device 100 is controlled by a microcontroller 120 or other microprocessor that executes stored routines. These routines may be stored in memory embedded in the microcontroller 120 or in external memory 122 in communication with the microcontroller 120. One of ordinary skill will recognize that the microcontroller 120 and memory 122 may be implemented in a number of functionally equivalent ways to provide operational control over the device 100. Typically, the microcontroller 120 communicates with the memory 122, the push button 108, and other circuitry via a bus or some other type of physical interface. For example, the microcontroller 120 will preferably interface with an analog-to-digital converter (not shown) in order to receive digitally formatted data representing voice input and will also interface with a digital-to-analog converter to convert data from the memory 122 in an appropriate format for the speaker 104. This functionality may be provided by separate circuitry or by a digital signal processor (DSP) that may incorporate its own embedded routines for processing data.

The memory 122, or other memory is used in the device 100 to store the audio input that is recorded. For example, the audio input would correspond to a number of different items to be purchased. In particular, the microcontroller 120 will sample the input at the microphone 102 when appropriate and record this input within memory 122. As mentioned above, the input is preferably converted to a digital form compatible with storage within the memory 122. The present invention contemplates a variety of different layouts for the memory 122. For example, each separately recorded input (e.g., each separate item to purchase) may be stored as a distinct data structure that is individually addressable. Such an arrangement would easily permit individual items to be deleted or retrieved. However, this arrangement may introduce some overhead in order to maintain address tables and pointers to each item. Another exemplary layout would append each newly recorded input at the end of the previously recorded input without any type of marker or separator between the inputs. This layout would efficiently use the memory 122 but may make it difficult for a user to change the contents of the memory 122. One of ordinary skill will recognize that other storage layouts are possible as well within the scope of the present invention. Regardless of the storage layout used by the device 100, as a consumer continues to use the device 100 to record input, the memory 122 will eventually hold a list of items to be purchased at a store.

A user interface 124 is included as part of the device 120 that provides a user with other options for controlling the device 100. In addition to the button 108 that allows a user to record an item as input, the interface 124 may include buttons or other input devices that permit the user to playback or scroll through the list of items, clear the list from memory, or to delete an item from the list. The interface 124 may also have buttons that resemble a tape recorder that allow a user to perform familiar functions such as rewind, fast-forward, and skip through the compiled item list. The device 100 also incorporates a wireless LAN interface 115 that will permit the device 100 to communicate over a wireless LAN.

Additional, optional elements may be included on the device 100 to provide a number of features that will simplify and enhance a trip to the store. For example, a bar-code scanner 110 may be included that a consumer might use to discover or confirm the price on an item in the store. When an item is scanned, the price may be output via the speaker 104 or may be displayed on the screen 112. The screen 112 is preferably a small LCD display that provides visual information to the consumer in addition to, or in place of, the audio output from the speaker 104.

In another embodiment, the device 100 may also include a barcode or other encoded identifier 114 that is associated with the consumer. Many retail establishments have rewards programs or other marketing-related programs that track purchases and provide rewards to shoppers. Many of these programs use a card or RF ID tag that is scanned at the cash register or point-of-sale. Thus, the device 100 may include the coded information 114, such as in the form of a sticker or label, to allow it to be used with conventional check-out scanners. The device 100 can thereby reduce the number of items that a consumer needs to carry and retrieve from a wallet or purse in order to complete the purchase.

A charging station or cradle 130 for the device 100 is shown in FIG. 1 as well. The device 100 will sit in the cradle 130 when not in use and receive power through a connector or other interface in order to recharge a battery or other energy source in the device 100. One alternative to the charging cradle 130 is to power the device 100 with replaceable batteries, much like a TV remote, that will require periodic replacement. The screen 112 or some other type of indicator may be used to display information about the state-of-charge of the device 100.

As will be described in more detail below, a consumer speaks into the device 100 to create a stored list of items that need to be purchased at a store. When the consumer arrives at the store with the device, the consumer might simply play back the recorded list and use the device 100 in much the same manner as a conventional written list. However, the store can greatly expand the functionality of the device 100 by providing an environment within the store that interfaces with the device 100 and the stored list of items. In one exemplary embodiment, the store itself provides the device 100 to its customers. Thus, the store will know exactly what the device 100 is capable of and will design the environment within its stores to take advantage of these capabilities.

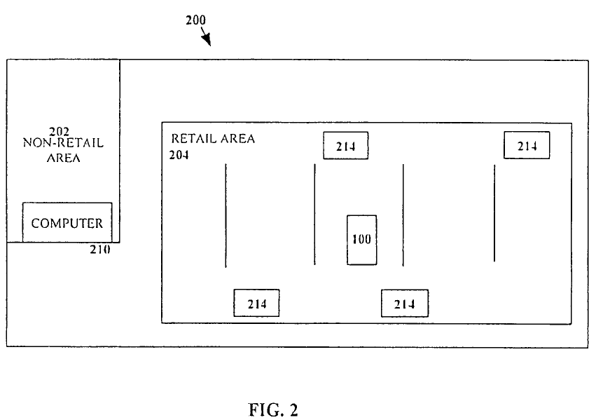

An exemplary store environment for using the device 100 is depicted in FIG. 2. This store 200 includes a non-retail area 202 where offices and other equipment is usually located and a retail area 204 where items for sale are kept and stocked. The retail area 204 is typically divided into various different zones. For example, grocery stores and many warehouse stores are arranged as a number of different aisles. Some furniture stores or clothing stores may not have such rigid separation but do typically include different departments that are physically segregated. The exemplary retail area 204 is depicted with aisles and therefore is similar to a typical grocery store layout.

Within the non-retail area 202 a computer 210 is located that supports a wireless LAN within the retail area 204. The coverage of this wireless LAN may extend to non-retail areas but the devices 100 will typically be located within the retail area 204 and thus, the description of the wireless LAN focuses on this area. Before discussing the details of the wireless LAN, the exemplary computer 210 is described in general terms as to its function and components.

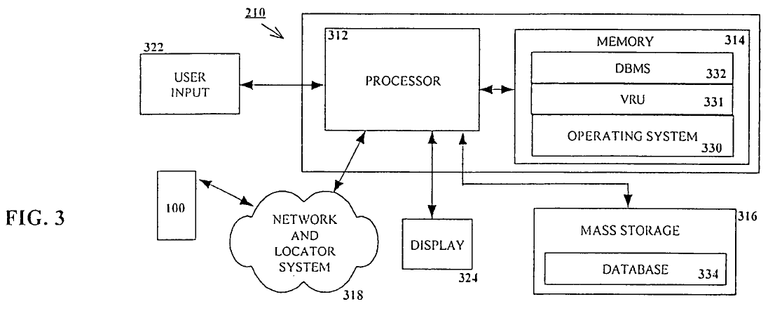

FIG. 3 illustrates an exemplary hardware and software environment for the server or computer 210 suitable for implementing an environment for utilizing and supporting the device 100 and similar devices consistent with the invention. For the purposes of the invention, the computer 210 may represent practically any type of computer, computer system or other programmable electronic device, including a client computer, a server computer, a portable computer, a handheld computer, an embedded controller, etc. Moreover, the computer 210 may be implemented using one or more networked computers, e.g., in a cluster or other distributed computing system.

Computer 210 typically includes at least one processor 312 coupled to a memory 314. Processor 312 may represent one or more processors (e.g., microprocessors), and memory 314 may represent the random access memory (RAM) devices comprising the main storage of computer 210, as well as any supplemental levels of memory, e.g., cache memories, non-volatile or backup memories (e.g., programmable or flash memories), read-only memories, etc. In addition, memory 14 may be considered to include memory storage physically located elsewhere in computer 210, e.g., any cache memory in a processor 312, as well as any storage capacity used as a virtual memory, e.g., as stored on a mass storage device 316 or on another computer or device coupled to computer 210 via the wireless network 318 or some other network (not shown).

Computer 210 also typically receives a number of inputs and outputs for communicating information externally. For interface with a user or operator, computer 210 typically includes one or more user input devices 322 (e.g., a keyboard, a mouse, a trackball, a joystick, a touchpad, and/or a microphone, among others) and a display 324 (e.g., a CRT monitor, an LCD display panel, and/or a speaker, among others). Otherwise, user input may be received via another device 100 interfaced with computer 210 over network 318, or via a dedicated workstation interface or the like.

For additional storage, computer 210 may also include one or more mass storage devices 316, e.g., a floppy or other removable disk drive, a hard disk drive, a direct access storage device (DASD), an optical drive (e.g., a CD drive, a DVD drive, etc.), and/or a tape drive, among others. Furthermore, computer 210 may include an interface with one or more networks 318 (e.g., a LAN, a WAN, a wireless network, and/or the Internet, among others) to permit the communication of information with other computers and devices coupled to the network. It should be appreciated that computer 210 typically includes suitable analog and/or digital interfaces between processor 312 and each of components 314, 316, 318, 322 and 324 as is well known in the art.

Computer 210 operates under the control of an operating system 330, and executes or otherwise relies upon various computer software applications, components, programs, objects, modules, data structures, etc. (e.g., database management system 332 and database 334, among others). Moreover, various applications, components, programs, objects, modules, etc. may also execute on one or more processors in another computer coupled to computer 210 via another network, e.g., in a distributed or client-server computing environment, whereby the processing required to implement the functions of a computer program may be allocated to multiple computers over the network.

Other hardware components may be incorporated into system 210, as may other software applications. In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

One particular application executing on the computer 210 is a voice-recognition application (VRU) 331. As is known in the art, a voice recognition application typically receives digitized voice input and determines which word or words are represented by that input. Additional processing processes the natural language input into a query understandable by the computer. The device 100 may include voice recognition capability as well but any such capability would be limited by the size of the device 100, its memory 122 and its microcontroller 120. Therefore, the computer 210 is the preferred choice for running the VRU 331 because the computer 210 will likely have more capability than that of the device 100.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein. Those skilled in the art will recognize that the exemplary environment illustrated in FIG. 3 is not intended to limit the present invention. Indeed, those skilled in the art will recognize that other alternative hardware and/or software environments may be used without departing from the scope of the invention.

Returning to FIG. 2, the computer 210 controls the wireless LAN 318 that operates within the retail area 204. As conventionally implemented, a wireless LAN 318 detects when a compatible device enters the coverage area of the LAN 318 and negotiates a connection with the device, such as device 100. As part of the negotiation process the device 100 typically provides a unique hardware identifier. If the store 200 retains records that associate a customer identifier with this hardware identifier, then the computer 210 will be able to determine when a particular consumer is shopping in the store 200. The LAN 318 may be configured to periodically poll for nearby devices or may be responsive to interrupts sent by nearby devices. Once the connection is established, devices on the LAN 318 communicate with one another using protocols similar to those of wired-LANs. One improvement to wireless LANs that is contemplated within certain embodiments of the present invention includes the provision of a “locator service” within the wireless LAN.

A number of commercially available locator services have been developed such as Symbol Technologies RTLS that operate within 802.11b wireless LANs. A locator service is used to determine the physical location of a networked device which is currently communicating over the wireless LAN. These services use a plurality of access points 214 that are located within the wireless LAN coverage area. The access points 214 receive normal operating signals from a device 100 on the wireless LAN and each create a packet that identifies the device 100 and has a timestamp reflecting when the signal was received. The computer 210 includes an application that receives these packets (which are typically sent over a dedicated hard-wire connection from the access points) and calculates a location for the device 100 based on the differences in the timestamps.

For the purpose of interfacing with the device 100 in accordance with one aspect of the present invention, the mass storage 316 of the computer 210 may contain more than one database 334. In particular, a database that represents the store layout cross-referenced by item type will allow the computer 210 to determine what items are near the detected location of the device 100. For example, if the device is aisle “7” of the retail area 204, then the computer 210 can determine that toothpaste and soap are on that aisle.

A database of current prices, discounts and special sale items may prove useful to the computer 210 as well for implementing the invention. For example, the computer 210 may use this information to announce specials to each new device 100 as it enters the retail area 204 or announce aisle-specific specials as a device 100 nears a particular aisle.

Another useful database, in one aspect of the present invention, is one that stores a history of purchases for a consumer associated with a particular device 100. If each device 100 includes an identifier that is cross-referenced with a particular consumer, then the computer 210, once it receives this identifier from the device 100, is able to determine the purchasing patterns for a consumer that enters the retail area 204. Using this purchasing history, the computer 210 may determine that a commonly bought item is on sale and generate an appropriate announcement; or the computer 210 may determine that a consumer has not purchased a particular item in a while and generates an announcement that highlights that item.

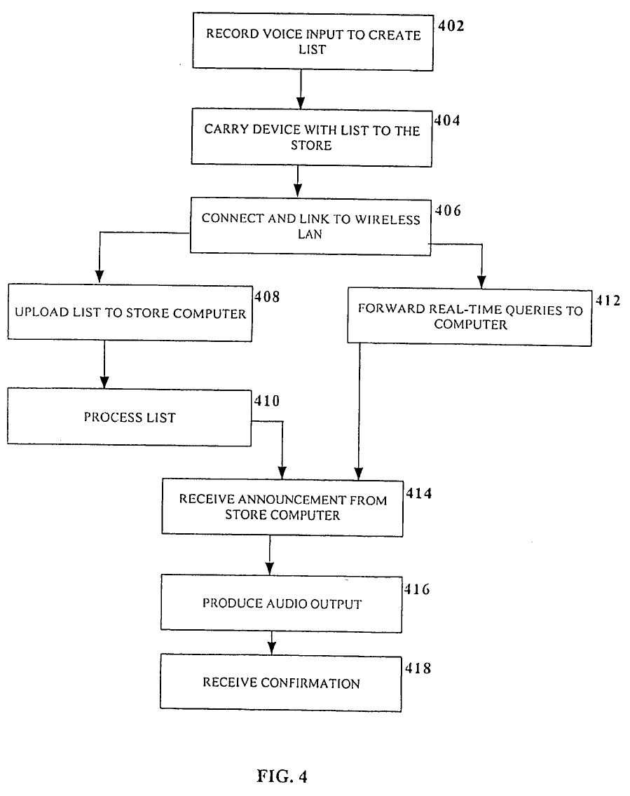

The device 100, the computer 210, and the store environment operate together in accordance with the principle of the present invention to permit the device 100 to enhance the shopping experience for a consumer within the store 200. FIG. 4 depicts a flowchart of an exemplary method of using the device 100 within the store 200. The method of FIG. 4 includes a number of features and functions that are not essential to the operation of the device 100. These features are described in order to highlight the robust capabilities of the device 100 and the store 200; however, embodiments of the present invention contemplate omitting one or more of these features as well. In order to provide a more concrete example, the method of FIG. 4 is described within the specific context of a grocery list. The present invention, however, is not limited in its application to only grocery stores or grocery lists. Use of the present invention within other types of retail establishments is contemplated as well. Furthermore, some embodiments of the present invention are not limited to only retail establishments. For example, a warehouse picker or other logistics personnel may find it beneficial to have a wireless device that stores a list of items that are to be found within a large warehouse or distribution center.

In step 402, a consumer uses the device 100 to record a list of items. The device 100 may be carried around with the consumer during the day or may be attached to its power cradle 130 for recharging. Thus, the consumer will periodically speak into the device 100, such as via a microphone or a headset, to record voice input representing an item to be purchased during the next trip to a store. As mentioned earlier, the device 100 may include features that allow the consumer to review and edit the list as desired.

In step 404, the consumer arrives at the store 200 along with the device 100. When the device 100 enters the coverage area of the wireless LAN 318 of the store 200, the device 100 and the computer 210 negotiate, in step 406, a connection of the device 100 onto the LAN 318. Once a device 100 is on the LAN 318, the device 100 may transmit an identifier to the computer 210 that identifies the consumer (or, more accurately, identifies the customer name associated with this particular device 100). If a locator service is running over the LAN 318, then the computer 210 will also be able to determine the physical location of the device 100 ans the consumer within the retail area 204.

In step 408, the device 100 uploads its list from its memory 122 to the computer 210. A specialized protocol may be developed for this file transfer or a commercially available file transfer algorithm may be implemented by the device 100 and computer 210. Regardless of how the list is transferred, the list is processed by the computer 210, in step 410. If voice recognition was performed by the device 100, then the computer 210 does not have to perform voice recognition as part of its processing of the list. However, assuming that the device 100 does not perform voice recognition, the processing of the list in step 410 includes analyzing the voice input data that was stored in the memory 122 to determine what store items are identified by the list. Thus, conventional voice recognition software executing on the computer 210 is used to convert the voice data to a format that the computer 210 can utilize when searching databases and generating announcements for the device 100. The processing in step 410 may also include cleaning the list to remove double-entries. During the processing of the list, the computer 210 may discover that one of the entries in the list is not identifiable. This condition may be reported to the device 100 with an appropriate announcement.

When the computer 210 receives a list and converts it to a useable format, then the computer 210 may use the list in a variety of ways to communicate helpful information to the user. To communicate information to the device 100, the computer 210 generates an announcement that is transmitted to the device 100 over the wireless LAN 318 and output from the speaker 104 as audio output. Typically, the computer 210 will encapsulate the announcement for transmission via the wireless LAN 318 and the device 100 will receive the announcement and translate it into a format for outputting from its speaker 104. Although, other equivalent methods for communicating these announcements are contemplated and considered within the scope of the present invention. Herein, these announcement from the computer 210 are conveniently referred to as “audio output” because eventually the announcement is emitted from the speaker of the device 100. However, the format of the announcement at different stages of transmission may not necessarily be what is conventionally considered as “audio” data.

When the computer 210 receives the list, it may simply produce announcements in the same order as the items in the list. Thus, the consumer may receive an announcement that toothpaste is located on aisle 7 and once that item is located then a next announcement may be received that soup is on aisle 1. However, providing the announcements in this order will likely result in the consumer traveling back and forth in the store 200.

Accordingly, a preferred method of producing announcements is for the computer 210 to process the list in step 210 in such a manner that considers location information associated with the items. Additionally, the computer 210 determines where the device 100 is located in the store 200. As the consumer approaches an aisle, the computer 210 will generate an announcement of items from the list that are located on that aisle. The computer 210 may also generate an announcement of specials that are located in that aisle or other information that pertains to that aisle, such as items this consumer routinely buys from this aisle.

In some instances a store 200 may have multiple entrances giving the consumer multiple options for traversing the store 200. In such instances, the computer 210 may determine the location of the consumer and identify an optimal path for the consumer to reach every item on the list. Based on the announcements received from the computer 210, the consumer can skip certain aisles in order to efficiently find the items on the list.

In addition to the device 100 passively receiving the announcements from the computer 210 and outputting them, the device 100 may be used in a real-time fashion to assist the consumer. For example, while within the store 200, the operation of the device 100 may change such that the push-to-talk button 108 results in voice input being sent, in step 412, to the computer 210 instead of recording the voice input in the memory 122. Thus, the consumer may ask questions such as “Where's milk?” and the computer 210 will receive the voice input, perform voice recognition, and generate an appropriate announcement in response. Similarly, the consumer may ask the computer 210 to repeat the items from the list that were located on a particular aisle in case the consumer forgets while on that aisle.

Regardless of whether the announcement is generated in response to the list being uploaded from the device 100 or from a real-time query, the device 100 will receive the announcement, in step 414, and output that announcement as audio output, in step 416. Once a consumer has retrieved an item, then a confirmation step may be performed in step 418 so that the computer 210 will be informed that the item was successfully located. When the consumer receives the announcement regarding toothpaste, the consumer may, for example, say “Got it”. The computer 210 will then remove that item from the list and move on to the next item. As a result, the computer 210 may download the remaining items on the list back to the device 100 when the consumer reaches the check-out area. In this way, the consumer will know which items were unavailable at the store.

Thus, while the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicants' general inventive concept.

For example, a detailed description of the exemplary operational environment involving retail establishments has been set forth. However, embodiments of the present invention also contemplate benefitting a warehouse picker or other logistics personnel by providing a wireless device that stores a list of items that are to be found within a large warehouse or distribution center.

As another example, the device 100 has been described herein as communicating over a wireless LAN 318 with the computer 210. In alternative embodiments, the device 100 may interface with a port or other docking station at the retail establishment that is hard-wired to the computer 210 via a conventional LAN. Once plugged-in, the device 10 would transmit the stored list to the computer 210 and, in response, receive back the list of items and their location in a predetermined order (such as numerical order of their aisle locations). The ordered list may be printed out at a nearby printer or visually displayed on the LCD screen of the device 100.

1. A method for assisting an individual in locating items, comprising the steps of:
recording speech input related to an item to locate in an area;
connecting to a network within the area;
receiving data identifying a location of the item in the area; and
generating audio output based on the received data.

2. The method according to claim 1, further comprising the step of:
determining a location of the individual within the area.

3. The method according to claim 1, wherein the speech input comprises a plurality of different items to locate in the area.

4. The method according to claim 3, further comprising the steps of:
generating respective audio output identifying a respective location of each of the plurality of different items.

5. The method according to claim 4, wherein the speech input occurred in a particular order and the respective audio output is generated in an order substantially the same as that particular order.

6. The method according to claim 4, further comprising the steps of:
determining an optimal path through the area for locating each of the plurality of different items; and
generating the respective audio output in an order according to the optimal path.

7. The method according to claim 1, further comprising the steps of:
receiving speech data related to a new item while in the area; and
generating audio output identifying a location of the new item in the area.

8. The method according to claim 1, further comprising the step of:
recording additional speech input related to a different item to locate in the area.

9. The method according to claim 1, further comprising the steps of:
producing audio output of the recorded speech input; and
in response to receiving an appropriate command, deleting the recorded speech input.

10. The method according to claim 1, wherein the area is a retail establishment.

11. A method for assisting an individual in locating items, comprising the steps of:
detecting a device storing recorded speech input related to an item to locate in an area;
retrieving the recorded speech input;
identifying the item from the retrieved recorded speech input; and
generating audio output identifying a location of the item in the area.

12. The method according to claim 11, further comprising the step of:
establishing a wireless network connection with the device.

13. The method according to claim 11, further comprising the step of:
transmitting the generated audio output to the device.

14. The method according to claim 11, further comprising the steps of:
detecting real-time speech input from the device;
identifying a new item based on the real-time speech input; and
generating additional audio output identifying a location of the new item in the area.

15. The method according to claim 11, wherein the recorded speech input comprises a plurality of different items to locate at the area.

16. The method according to claim 15, further comprising the steps of:
creating respective audio output identifying a respective location of each of the plurality of different items.

17. The method according to claim 16, further comprising the steps of:
determining an optimal path through the area for locating each of the plurality of different items; and
transmitting the respective audio output, to the device, in an order according to the optimal path.

18. The method according to claim 11, wherein the area is a retail establishment.

19. A method for assisting an individual in a retail establishment, comprising the steps of:
storing an identifier for the individual, said identifier correlated to a historical record of activity of the individual within the retail establishment;
connecting to a network within the retail establishment;
receiving data about an item in the retail establishment based on the historical record; and
generating output based on the received data.

20. A method for assisting an individual in a retail establishment, comprising the steps of:
detecting a device associated with an identifier of the individual;
based on the identifier, retrieving data from a historical record of activity of the individual within the retail establishment;
identifying an item based on the retrieved data; and
generating audio output related to the item.

21. The method according to claim 20, further comprising the steps of:
transmitting the generated audio output to the device.

22. A wireless assistance system within an area, comprising:
a programmable computer configured to execute a software application to assist an individual in locating a desired item within the area;
a first database, in communication with the programmable computer, storing an identification of a plurality of items in the area and their respective physical locations;
a receiver, in communication with the programmable computer, configured to retrieve the desired item identification from a wireless device within the area;
the software application configured to retrieve from the first database, the respective physical location of the desired item; and
a transmitter, in communication with the first computer, configured to send the respective physical location of the desired item to the wireless device.

23. The system of claim 22, wherein the area is a retail establishment.

24. The system of claim 22, wherein the desired item identification comprises recorded voice data.

25. The system of claim 22, wherein the transmitter is further configured to send the respective physical location as audio data.

26. The system of claim 22, wherein the desired item identification comprises a real-time voice query.

27. The system of claim 22, wherein the receiver is further configured to receive a location of the wireless device.

28. A wireless apparatus providing assistance to an individual within an area, comprising:
speech input circuitry configured to capture speech data related to a desired item;
interface circuitry configured to connect with a wireless network within the area;
transmitter circuitry configured to utilize the interface circuitry to transmit an identifier of the desired item, over the wireless network, based on the speech data;
receiver circuitry configured to receive, over the wireless network, a location within the area of the desired item; and
audio output circuitry configured to generate synthesized speech of the location.

29. The apparatus of claim 28, wherein the speech input circuitry is further configured to record the speech data.

30. An apparatus comprising:
at least one processor;
a memory coupled with the at least one processor; and
a program code residing in memory and executed by the at least one processor, the program code configured to:
detect a device storing recorded speech input related to an item to locate in an area;
establish a wireless network connection with the device
retrieve the recorded speech input;
identify the item from the retrieved recorded speech input; and
transmit, to the wireless device, audio output identifying a location of the item in the area.

31. A program product, comprising:
a program code configured upon execution to:
detect a device storing recorded speech input related to an item to locate in an area;
establish a wireless network connection with the device
retrieve the recorded speech input;
identify the item from the retrieved recorded speech input; and
transmit, to the wireless device, audio output identifying a location of the item in the area; and
a signal bearing medium bearing the program code.

32. A method for assisting a consumer in the purchasing of items, comprising the steps of:
generating a list of desired items using audio inputs to a device;
transferring the list to a network in an area containing at least one of the desired items;
obtaining, from the network, a location of the at least one item within the area; and
communicating the location to the consumer.

33. The method of claim 32, wherein the network comprises a wireless LAN.

34. The method of claim 32, wherein the step of communicating further includes the step of:
producing audio output related to the location.

35. The method of claim 32, wherein the step of communicating further includes the step of:
producing visual output related to the location.

36. The method of claim 35 wherein the output identifies the at least one item and the location.

37. A shopping assistance system, comprising:
a plurality of mobile devices, each configured to capture an audio input indicative of a respective list of desired items;
a system configured to communicate with the mobile devices and to store location information related to items in an area; and
the system further configured to capture the respective list from a particular one of the mobile devices and output to the particular one mobile device a respective location for each desired item on the respective list.
